(19) United States
(12) Patent Application Publication
(10) Pub. No.: US 2008/0114660 A1
(43) Pub. Date: May 15, 2008

(54) SYSTEM AND METHOD FOR TRANSLATING BILL OF MATERIAL INFORMATION FOR VEHICLE COMPONENTS

(75) Inventors: Gahl Berkooz, Ann Arbor, MI (US); David Wilson, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 11/554,735

(22) Filed: Oct. 31, 2006

(51) Int. Cl. G06Q 20/00

(52) U.S. Cl. 705/23

(57) ABSTRACT

Systems and methods are provided for translating between bills of material based on an identifier associated with a component definition and a function definition. The component definition and the function definition are a component and function definition for a bill of material such that another component from that bill of material having a different function does not satisfy the component and function definition.

### BACKGROUND OF THE INVENTION

1. Field of the Invention

The invention relates to systems and methods for translating bill of material information for vehicle components.

2. Background

The bill of material for a vehicle may contain information describing each of the components used in that vehicle.

Different manufacturers may describe components differently and thus have different bills of material given the same components. For example, a first manufacturer may describe a component, inter alia, in terms of a part number. A second manufacturer may describe the same component, inter alia, in terms of a system number. The information associated with the part number of the first manufacturer and the system number of the second manufacturer may be such that a component having a single part number for the first manufacturer's bill of material may have multiple system numbers for the second manufacturer's bill of material. As such, a part number from a first bill of material may not map directly to a system number from a second bill of material.

This lack of mapping, or translating, may pose difficulties for manufacturers if they wish to collaborate or share components between vehicles. For example, if two manufacturers are jointly developing a component, a change to the bill of material of one manufacturer may require a change to the bill of material of the other manufacturer. The corresponding bill of material information of the other manufacturer, however, may not be easily identifiable.

### SUMMARY

In at least one embodiment, the invention takes the form of a computer-implemented system for translating bill of material information for vehicle components. The system includes a computer that receives input defining a first component included in a first bill of material and receives input defining a first function of the first component. The first component definition and the first function definition are a first component and function definition for the first bill of material such that another component from the first bill of material having a different function does not satisfy the first component and function definition. The computer also receives input defining a second component included in a second bill of material and receives input defining a second function of the second component. The second component definition and the second function definition are a second component and function definition for the second bill of material such that another component from the second bill of material having a different function does not satisfy the second component and function definition. The computer further receives input defining a common identifier, associates the first component with the common identifier based on the first component and function definition, and associates the second component with the common identifier based on the second component and function definition thereby translating the first bill of material to the second bill of material.

In at least one embodiment, the invention takes the form of a method for translating bill of material information for vehicle components. The method includes receiving input defining a first component included in a first bill of material and receiving input defining a first function of the first component. The first component definition and the first function definition are a first component and function definition for the first bill of material such that another component from the first bill of material having a different function does not satisfy the first component and function definition. The method also includes receiving input defining a second component included in a second bill of material and receiving input defining a second function of the second component. The second component definition and the second function definition are a second component and function definition for the second bill of material such that another component from the second bill of material having a different function does not satisfy the second component and function definition. The method further includes receiving input defining a common identifier, associating the first component with the common identifier based on the first component and function definition, and associating the second component with the common identifier based on the second component and function definition thereby translating the first bill of material to the second bill of material.

In at least one embodiment, the invention takes the form of a method for translating bill of material information for vehicle components. The method includes identifying first component data defining a first component included in a first bill of material and identifying first function data defining a function of the first component. The first component definition and the first function definition are a first component and function definition for the first bill of material such that another component of the first bill of material having a different function does not satisfy the first component and function definition. The method also includes identifying second component data defining a second component included in a second bill of material and identifying second function data defining a function of the second component. The second component definition and the second function definition are a second component and function definition for the second bill of material such that another component of the second bill of material having a different function does not satisfy the second component and function definition. The method further includes assigning a common identifier to the first component based on the first component and function definition and assigning the common identifier to the second component based on the second component and function definition thereby translating the first bill of material to the second bill of material.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 shows a system for translating bill of material information for vehicle components in accordance with an embodiment of the invention.

FIG. 2 shows the system of FIG. 1 in greater detail.

FIG. 3 shows an example algorithm used to associate common identifier information with bill of material information.

FIGS. 4a-4c show input and output screens in accordance with an embodiment of the invention.

FIG. 5 shows a method for translating bill of material information for vehicle components in accordance with an embodiment of the invention.

FIG. 6 shows a method for translating bill of material information for vehicle components in accordance with an embodiment of the invention.

FIG. 7 shows an example algorithm for identifying a component definition and function definition for a component in accordance with an embodiment of the invention.

### DETAILED DESCRIPTION

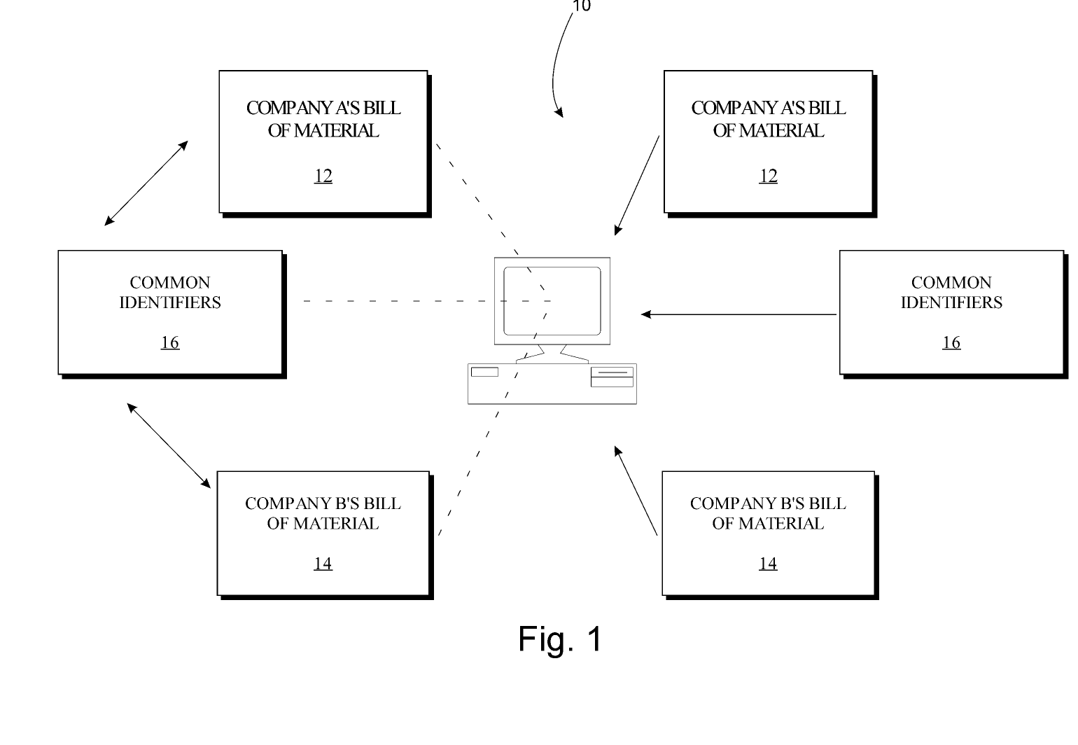

FIG. 1 shows computer-implemented system 10 for translating bill of material information for vehicle components. System 10 receives first bill of material (BOM) 12, e.g., Company A's BOM, defining a first component and a first function of the first component as will be explained in detail below, second bill of material 14, e.g., Company B's BOM, defining a second component and a second function of the second component as will be explained in detail below, and common identifiers 16. System 10 uses common identifiers 16 to translate between BOM 12 and BOM 14 as will be explained in detail below.

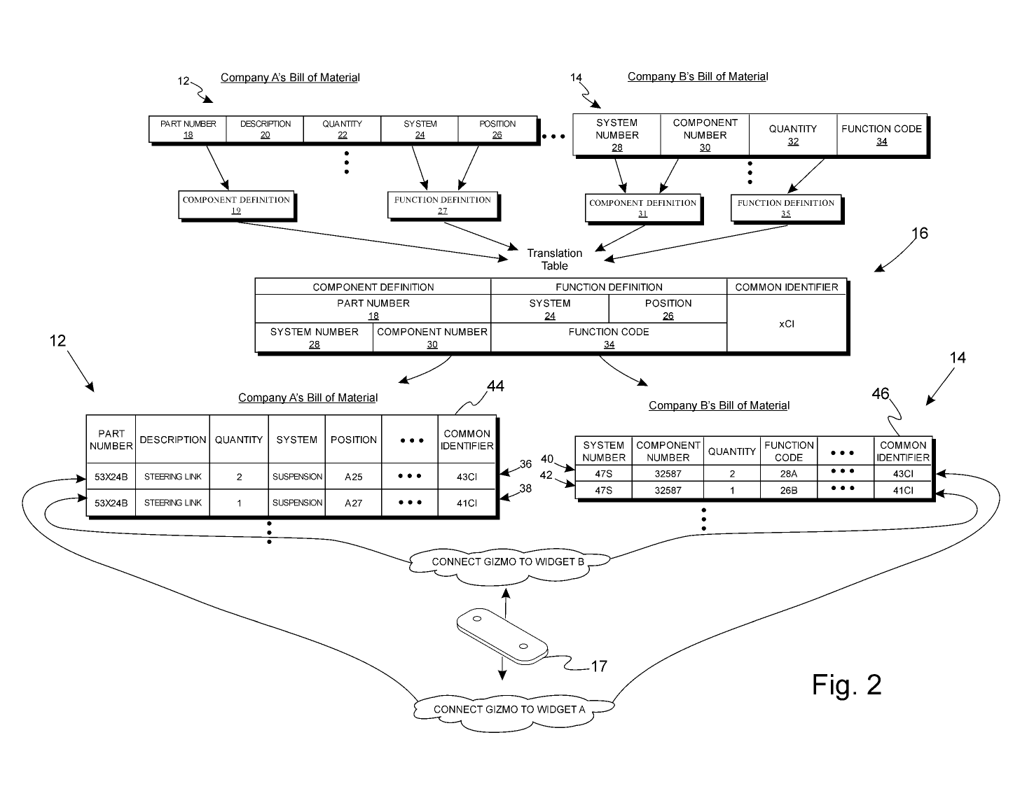

FIG. 2 shows an example BOM 12 and BOM 14 in greater detail. BOM 12 and BOM 14 use different types of information to describe and identify vehicle components, e.g., link 17. In this example, link 17 has two separate functions within a vehicle: “CONNECT GIZMO TO WIDGET A” and “CONNECT GIZMO TO WIDGET B.”

BOM 12 includes part number 18, description 20, quantity 22, system 24, and position 26 information for each component included in BOM 12. Different or other information may be included in BOM 12.

Part number 18, e.g., 53X24B, identifies physically unique components such that all components having the same part number 18 are physically the same but need not perform the same function within a vehicle. Further, components having different part numbers 18 are not physically the same. In this example, component definition 19 is part number 18 as will be explained in detail below.

Description 20, e.g., steering link, provides a brief textual description of a component.

Quantity 22 indicates the number of components having the same part number 18 and function, as will be explained in detail below, required in a vehicle.

System 24, e.g., suspension, and position 26, e.g., A25, together indicate the function of a component such that components having the same part number 18 but different system 24 or position 26 information do not perform the same function in a vehicle. In this example, function definition 27 is system 24 and position 26.

BOM 14 includes system number 28, component number 30, quantity 32, and function code 34 information for each component included in BOM 14. Different or other information may be included in BOM 14.

System number 28, e.g., 47S, and component number 30, e.g., 32587, together identify physically unique components such that all components having the same system number 28 and component number 30 are physically the same but need not perform the same function within a vehicle. Further, components having different system numbers 28 or component numbers 30 are not physically the same. In this example, component definition 31 is system number 28 and component number 30 as will be explained below in detail.

Quantity 32 indicates the number of components having the same system number 28 and component number 30 and function, as will be explained in detail below, required in a vehicle.

Function code 34 indicates the function of a component such that components having the same system number 28 and component number 30 but different function code 34 information do not perform the same function in a vehicle. In this example, function definition 35 is function code 34.

Component definition 19 and function definition 27 together are unique such that components having a different component definition 19 or a different function definition 27 do not satisfy both component definition 19 and function definition 27. For example, FIG. 2 shows that for row 36, the part number “53X24B,” the system “SUSPENSION,” and position “A25” are unique in that for row 38, the part number “53X24B” with the system “SUSPENSION” and the position “A27” do not satisfy component definition 19 and function definition 27 of row 36.

Component definition 31 and function definition 35 together are unique such that components having a different component definition 31 or a different function definition 35 do not satisfy both component definition 31 and function definition 35. For example, FIG. 2 shows that for row 40, the system number “47S” and the component number “32587” with function code “28A” do not satisfy component definition 31 and function code 35 of row 42.

FIG. 2 shows translation table 16 having an example common identifier. Translation table 16 has a unique common identifier for each unique component and function definition pair. For example, part number “53X24B”, system “SUSPENSION,” and position “A25” are assigned the common identifier “43CI.” Further, system number “47S,” component number “32587,” and function code “28A” are assigned the common identifier “43CI.” Upon receiving BOM 12, BOM 14, and common identifiers 16, system 10 associates the information from BOM 12 and BOM 14 with the information from common identifiers 16. For example, FIG. 2 shows that BOM 12 and BOM 14 include an additional column of data 44, 46 respectively containing the common identifier information.

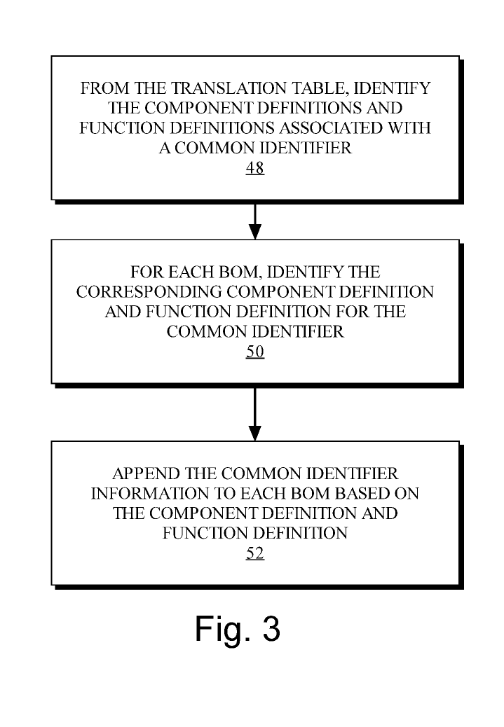

System 10 may associate common identifiers with BOM 12 and BOM 14 in any desired fashion. FIG. 3 shows an example algorithm used to associate common identifiers 16 with BOM 12 and BOM 14.

At step 48, system 10 identifies the component definitions and function definitions associated with a common identifier, e.g., system 10 identifies from translation table 16 that, for BOM 12, part number “53X24B,” system “SUSPENSION,” and position “A25” are the component definition and function definition associated with the common identifier “43CI” and that, for BOM 14, system number “47S,” component number “32587,” and function code “28A” are the component definition and function definition also associated with the common identifier “43CI.” At step 50, for each BOM, system 10 identifies the corresponding component definition and function definition for the common identifier, e.g., the information of row 36 contains the component definition and function definition associated with the common identifier “43CI” and the information of row 40 contains the component definition and function definition for the common identifier “43CI.”

At step 52, system 10 appends the common identifier information to each BOM based on the component definition and function definition, e.g., system 10 appends the common identifier information to the existing information of BOM 12 and BOM 14 in columns 44, 46 respectively.

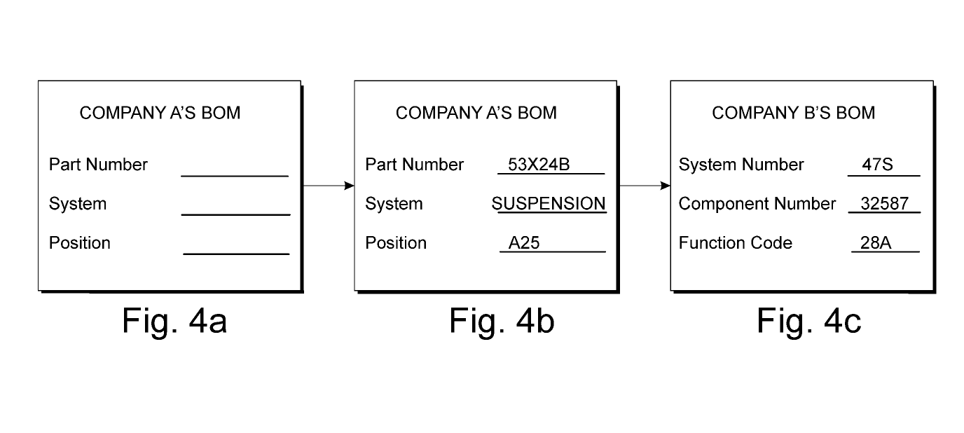

System 10 translates between BOM 12 and BOM 14. FIG. 4a shows a screen permitting a user to enter in the component definition and function definition for a component from BOM 12. FIG. 4b shows that the user entered in the part number “53X24B”, the system “SUSPENSION,” and the position “A25.” Based on the component definition and the function definition, and using the associated common identifier as explained above, FIG. 4c shows that system 10 returns the component definition and function definition of the same part having the same function, e.g., the system number “47S,” the component number “32587,” and the function code “28A.”

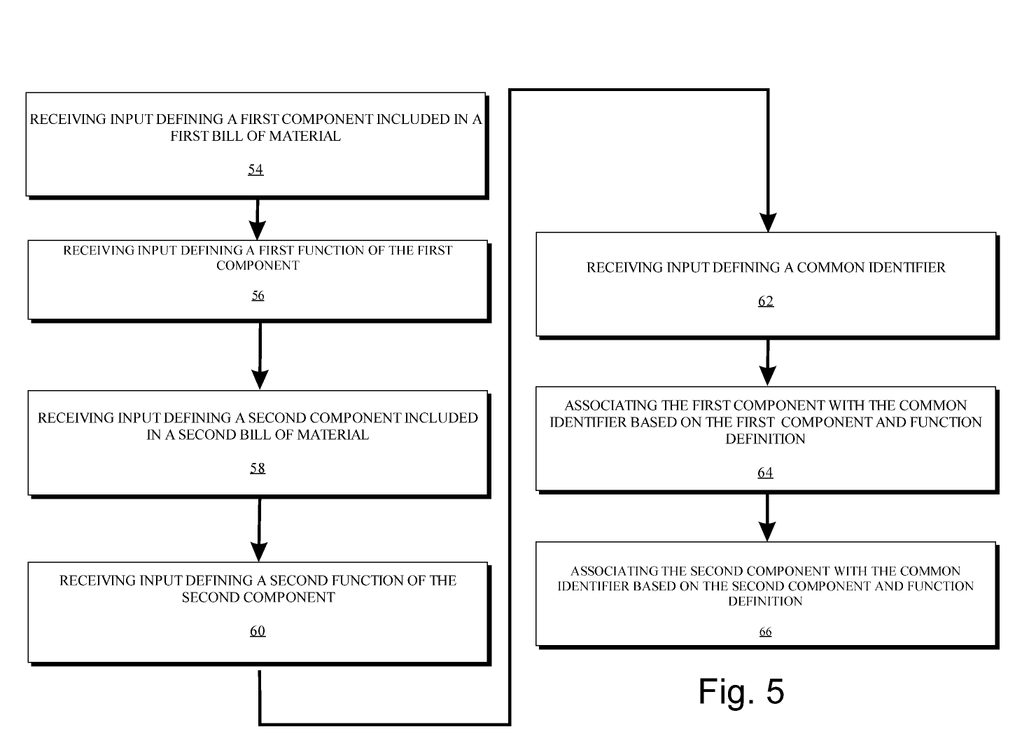

FIG. 5 shows a method for translating bill of material information for vehicle components.

At step 54, input defining a first component included in a first bill of material is received.

At step 56, input defining a first function of the first component is received. The first component definition and the first function definition are a first component and function definition for the first bill of material such that another component of the first bill of material having a different function does not satisfy the first component and function definition.

At step 58, input defining a second component included in a second bill of material is received.

At step 60, input defining a second function of the second component is received. The second component definition and the second function definition are a second component and function definition for the second bill of material such that another component of the second bill of material having a different function does not satisfy the second component and function definition.

At step 62, input defining a common identifier is received.

At step 64, the first component is associated with the common identifier based on the first component and function definition.

At step 66, the second component is associated with the common identifier based on the second component and function definition. The first bill of material is thereby translated to the second bill of material.

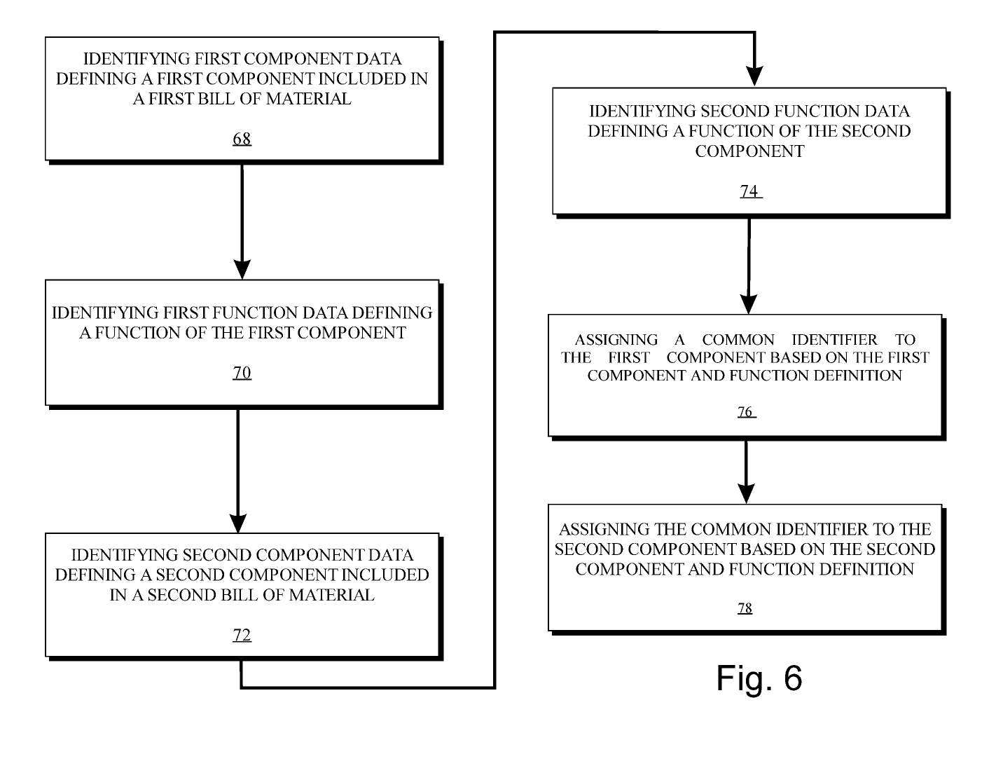

FIG. 6 shows a method for translating bill of material information for vehicle components.

At step 68, first component data defining a first component included in a first bill of material is identified.

At step 70, first function data defining a function of the first component is identified. The first component definition and the first function definition are a first component and function definition for the first bill of material such that another component of the first bill of material having a different function does not satisfy the first component and function definition.

At step 72, second component data defining a second component included in a second bill of material is identified.

At step 74, second function data defining a function of the second component is identified. The second component definition and the second function definition are a second component and function definition for the second bill of material such that another component of the second bill of material having a different function does not satisfy the second component and function definition.

At step 76, a common identifier is assigned to the first component based on the first component and function definition.

At step 78, the common identifier is assigned to the second component based on the second component and function definition. The first bill of material is thereby translated to the second bill of material.

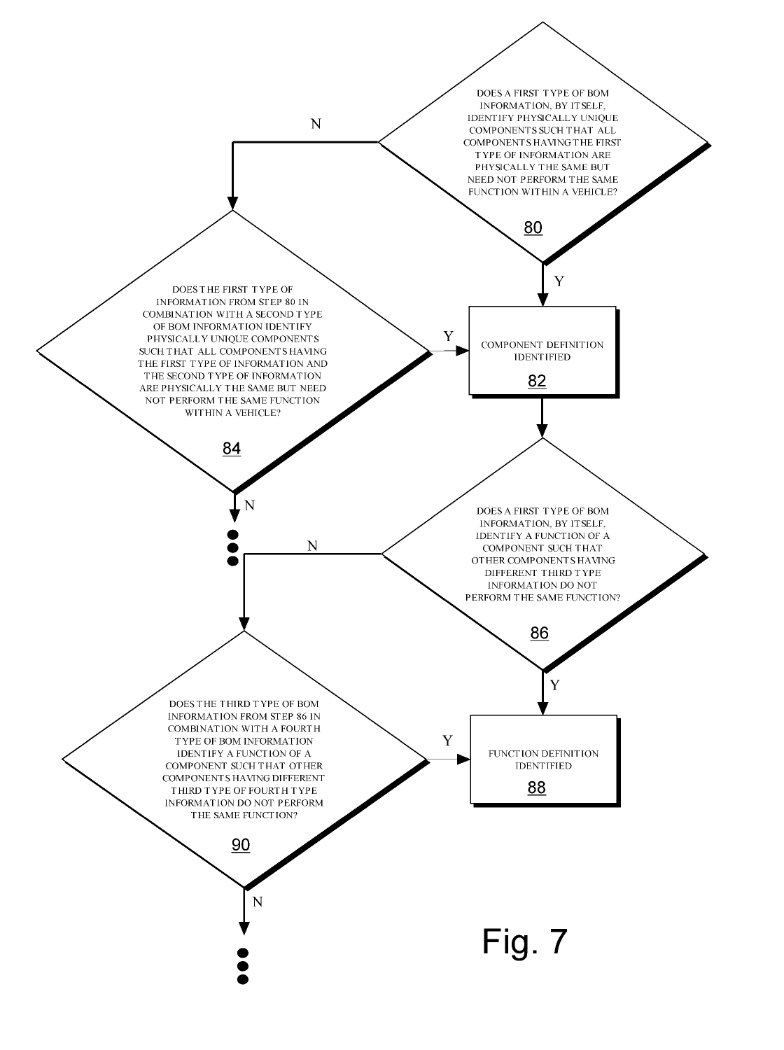

FIG. 7 shows an example algorithm for identifying a component definition and function definition for a component.

At step 80, it is determined whether a first type of BOM information, e.g., part number, system number, component number, or quantity, by itself, identifies physically unique components such that all components having the first type of information are physically the same but need not perform the same function within a vehicle. From the examples above, part number 18 of BOM 12 identifies physically unique components such that all components having the same part number 18 are physically the same but need not perform the same function within a vehicle.

If yes, at step 82, a component definition is identified, e.g., part number 18 of BOM 12 is the component definition.

If no, at step 84, it is determined whether the first type of BOM information from step 80 in combination with a second type of BOM information identify physically unique components such that all components having the first type of information and the second type of information are physically the same but need not perform the same function within a vehicle. From the examples above, system number 28 and component number 30 from BOM 14 identify physically unique components such that all components having the same system number 28 and component number 30 are physically the same but need not perform the same function within a vehicle.

If yes, at step 82, a component definition is identified.

If no, the algorithm can be expanded to include a third, fourth, etc., type of information.

At step 86, it is determined whether a third type of BOM information, by itself, identifies a function of a component such that other components having different third type information do not perform the same function. From the examples above, function code 34 of BOM 14 identifies a function of a component such that other components having a different function code 34 do not perform the same function.

If yes, at step 88, a function definition is identified.

If no, at step 90, it is determined whether the third type of BOM information from step 86 in combination with a fourth type of BOM information identify a function of a component such that other components having different third type or fourth type information do not perform the same function. From the examples above, system 24 and position 26 of BOM 12 identify a function of a component such that other components having different system 24 or position 26 information do not perform the same function.

If yes, at step 88, a function definition is identified.

If no, the algorithm can be expanded to include a fifth, sixth, etc., type of information.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A computer-implemented system for translating bill of material information for vehicle components comprising:
a computer configured to
receive input defining a first component included in a first bill of material,
receive input defining a first function of the first component, the first component definition and the first function definition being a first component and function definition for the first bill of material such that another component from the first bill of material having a different function does not satisfy the first component and function definition,
receive input defining a second component included in a second bill of material,
receive input defining a second function of the second component, the second component definition and the second function definition being a second component and function definition for the second bill of material such that another component from the second bill of material having a different function does not satisfy the second component and function definition,
receive input defining a common identifier,
associate the first component with the common identifier based on the first component and function definition, and
associate the second component with the common identifier based on the second component and function definition thereby translating the first bill of material to the second bill of material.

2. The system of claim 1 wherein the first and second functions are the same.

3. The system of claim 1 wherein the first and second components are the same.

4. The system of claim 1 wherein the input defining a first component includes a part number.

5. The system of claim 1 wherein the input defining a second component includes a part number.

6. A method for translating bill of material information for vehicle components comprising:
receiving input defining a first component included in a first bill of material;
receiving input defining a first function of the first component, the first component definition and the first function definition being a first component and function definition for the first bill of material such that another component from the first bill of material having a different function does not satisfy the first component and function definition;
receiving input defining a second component included in a second bill of material;
receiving input defining a second function of the second component, the second component definition and the second function definition being a second component and function definition for the second bill of material such that another component from the second bill of material having a different function does not satisfy the second component and function definition;
receiving input defining a common identifier;
associating the first component with the common identifier based on the first component and function definition; and
associating the second component with the common identifier based on the second component and function definition thereby translating the first bill of material to the second bill of material.

7. The method of claim 6 wherein the first and second functions are the same.

8. The method of claim 6 wherein the first and second components are the same.

9. The method of claim 6 wherein the input defining a first component includes a part number.

10. The method of claim 6 wherein the input defining a second component includes a part number.

11. A method for translating bill of material information for vehicle components comprising:
identifying first component data defining a first component included in a first bill of material;
identifying first function data defining a function of the first component, the first component definition and the first function definition being a first component and function definition for the first bill of material such that another component of the first bill of material having a different function does not satisfy the first component and function definition;
identifying second component data defining a second component included in a second bill of material;
identifying second function data defining a function of the second component, the second component definition and the second function definition being a second component and function definition for the second bill of material such that another component of the second bill of material having a different function does not satisfy the second component and function definition;
assigning a common identifier to the first component based on the first component and function definition; and
assigning the common identifier to the second component based on the second component and function definition thereby translating the first bill of material to the second bill of material.

12. The method of claim 11 wherein the functions of the first and second components are the same.

13. The method of claim 11 wherein the first and second components are the same.

14. The method of claim 11 wherein the first component data includes a part number.

15. The method of claim 11 wherein the second component data includes a part number.

16. The method of claim 11 further comprising determining whether another component included in the first bill of material satisfies the first component definition.

17. The method of claim 11 further comprising determining whether a function of another component included in the first bill of material satisfies the first function definition.

18. The method of claim 11 further comprising determining whether another component included in the second bill of material satisfies the second component definition.

19. The method of claim 11 further comprising determining whether a function of another component included in the second bill of material satisfies the second function definition.
